(19) United States
(12) Patent Application Publication
(10) Pub. No.: US 2019/0283704 A1
(43) Pub. Date: Sep. 19, 2019

(54) HARNESS RESTRAINT LOCK

(71) Applicant: Sikorsky Aircraft Corporation, Stratford, CT (US)

(72) Inventors: Barton J. Hainsworth, Oxford, CT (US); Alex Eberhardt, Seymour, CT (US); Scott A. Benavides, Troy, NY (US)

(21) Appl. No.: 15/923,664

(22) Filed: Mar. 16, 2018

(51) Int. Cl. B60R 22/185; B64D 11/06; B60R 22/14; B60R 22/26

(52) U.S. Cl. CPC B60R 22/185; B60R 22/26; B60R 22/14; B64D 11/062

(57) ABSTRACT

A harness includes a primary locking mechanism, at least one strap of webbing coupled to a primary locking mechanism, and a secondary locking mechanism associated with the at least one strap of webbing. The secondary locking mechanism is located downstream from the primary locking mechanism and is movable to selectively contact the at least one strap of webbing to restrict movement of the at least one strap of webbing relative to the secondary locking mechanism.

### STATEMENT OF FEDERAL SUPPORT

This invention was made with Government support under FA8629-14-C-2403 awarded by the Air Force. The Government has certain rights in the invention.

### BACKGROUND

Embodiments pertaining to the present disclosure relate to a harness arrangement for a vehicle, and more particularly, to a secondary locking mechanism for restricting movement of the webbing of a harness.

Harnesses used in a vehicle, such as an aircraft for example, typically includes a plurality of straps, for example shoulder straps passing from a seat over respective shoulders of an occupant of the seat and a pair of waist straps passing from the seat at least partially around a waist of the occupant from respective sides. A free end of each of the straps includes a connector configured to releasably engage with a quick release locking arrangement. Accordingly, it will therefore be understood that conventional aircraft seat harnesses are multi-point arrangements, comprising a number of straps which all engage within a single locking arrangement which includes actuating means that the occupant can trigger to selectively release the plurality of straps to egress from the seat.

Crew members of a vehicle often require mobility to perform mission duties while still being provided with adequate protection in the event of a severe maneuver, crash, or other impact event. For example, the mission duties of helicopter crew members (e.g. gunners, flight engineers, load masters) can require that the crew members be seated, standing, kneeling, or moving about. The harnesses used by such crew members additionally include one or more inertia devices that allow the straps of webbing of the harness to freely pay out under normal conditions, but lock when the webbing accelerates rapidly to prevent crew from being ejected or the user needs to use the webbing to lean against the tethered position. An example of such an inertia reel and the webbing connected thereto is illustrated in FIG. 10. During normal operation, the webbing material is taken up by the inertia reel via a plurality of layers wrapped loosely about a spool, as shown in the FIG. When a rapid acceleration is applied to the webbing, the spool inside the inertia reel does not rotate. However, because the layers of webbing are loosely wound about the spool, the force applied to the webbing will remove the slack in the material such that the layers become tightly compressed about the spool and each other, as shown in FIG. 11. This compaction and the elimination of the slack in the wrapped webbing may allow a substantial portion of the webbing material, as illustrated by marker A in the FIGS., to move relative to the inertia reel, Accordingly, undesirable movement of a person wearing the harness associated with the inertia reel may occur.

### BRIEF DESCRIPTION

According to an embodiment, a harness includes a primary locking mechanism, at least one strap of webbing coupled to a primary locking mechanism, and a secondary locking mechanism associated with the at least one strap of webbing. The secondary locking mechanism is located downstream from the primary locking mechanism and is movable to selectively contact the at least one strap of webbing to restrict movement of the at least one strap of webbing relative to the secondary locking mechanism.

In addition to one or more of the features described above, or as an alternative, in further embodiments the secondary locking mechanism is movable to restrict movement of the at least one strap of webbing without applying a load to the primary locking mechanism.

In addition to one or more of the features described above, or as an alternative, in further embodiments the secondary locking mechanism further comprises a first portion and a second portion. The first portion is movable relative to the second portion between a first position and a second position, wherein in the first position, a clearance is defined between the first portion and the second portion.

In addition to one or more of the features described above, or as an alternative, in further embodiments the at least one strap of webbing extends through the clearance.

In addition to one or more of the features described above, or as an alternative, in further embodiments when the first portion and the second portion are in the second position, the at least one strap of webbing is clamped between the first portion and the second portion.

In addition to one or more of the features described above, or as an alternative, in further embodiments the first portion is linearly movable between the first position and the second position.

In addition to one or more of the features described above, or as an alternative, in further embodiments the first portion is rotatable between the first position and the second position.

In addition to one or more of the features described above, or as an alternative, in further embodiments the first portion includes a first contact member, wherein engagement between the first contact member and the at least one strap of webbing does not damage the at least one strap of webbing.

In addition to one or more of the features described above, or as an alternative, in further embodiments the first contact member is formed from a rubber material.

In addition to one or more of the features described above, or as an alternative, in further embodiments comprising a control device coupled to the first portion to control movement of the first portion relative to the second portion between the first position and the second position.

In addition to one or more of the features described above, or as an alternative, in further embodiments the control device is manually operable by an occupant wearing the harness.

In addition to one or more of the features described above, or as an alternative, in further embodiments the control device is one of an actuator and a control cable assembly.

In addition to one or more of the features described above, or as an alternative, in further embodiments the locking mechanism further comprises a biasing mechanism that biases the first portion into the second position.

In addition to one or more of the features described above, or as an alternative, in further embodiments the control device is operable to oppose the biasing mechanism to retain the first portion in the first position.

In addition to one or more of the features described above, or as an alternative, in further embodiments the primary locking mechanism includes an inertia reel, the at least one strap of webbing being affixed to and wound about a spool of the inertia reel.

In addition to one or more of the features described above, or as an alternative, in further embodiments the secondary locking mechanism is arranged downstream from an outlet of the inertia reel.

In addition to one or more of the features described above, or as an alternative, in further embodiments the harness is coupled to a seat.

In addition to one or more of the features described above, or as an alternative, in further embodiments the harness allows a user to move between a seated position and a standing position, and in the standing position the user may perform one or more mission tasks.

In addition to one or more of the features described above, or as an alternative, in further embodiments the harness is integrated into a vehicle.

In addition to one or more of the features described above, or as an alternative, in further embodiments the vehicle is an aircraft.

### BRIEF DESCRIPTION OF THE DRAWINGS

The following descriptions should not be considered limiting in any way. With reference to the accompanying drawings, like elements are numbered alike:

FIG. 1 is a perspective view of an example of a seat including a harness system;

FIG. 2 is a schematic view of a vehicle occupant wearing a harness, the occupant being seated according to an embodiment;

FIG. 3 is a schematic view of a vehicle occupant wearing a harness, the occupant standing at a position forward of the seat according to an embodiment;

FIG. 4 is a cross-sectional view of an example of an inertia reel of the harness system;

FIG. 5 is a schematic diagram of a locking mechanism configured to cooperate with an inertia reel of the harness system according to an embodiment;

FIGS. 6A and 6B are schematic diagrams of the locking mechanism of FIG. 5 in an open configuration and a closed configuration according to an embodiment;

FIGS. 7A and 7B are schematic diagrams of the locking mechanism of FIG. 5 in an open configuration and a closed configuration according to an embodiment;

FIG. 8 is a schematic view of a vehicle occupant wearing a harness including the locking mechanism, the occupant being seated according to an embodiment;

FIG. 9 is a schematic view of a vehicle occupant wearing a harness including the locking mechanism, the occupant standing at a position forward of the seat according to an embodiment;

FIG. 10 is an example of an inertia reel during normal operation; and

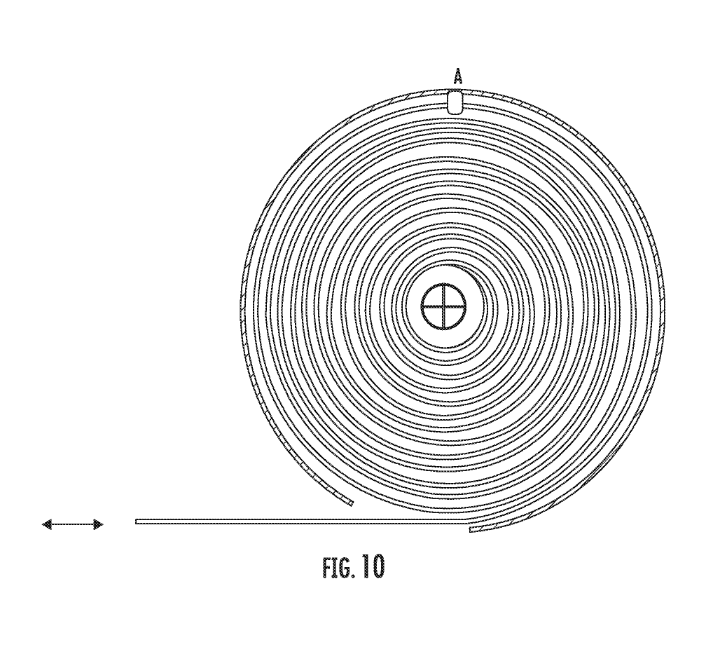

FIG. 11 is a schematic diagram of an inertia reel in response to a rapid acceleration of the webbing coupled to the inertia reel.

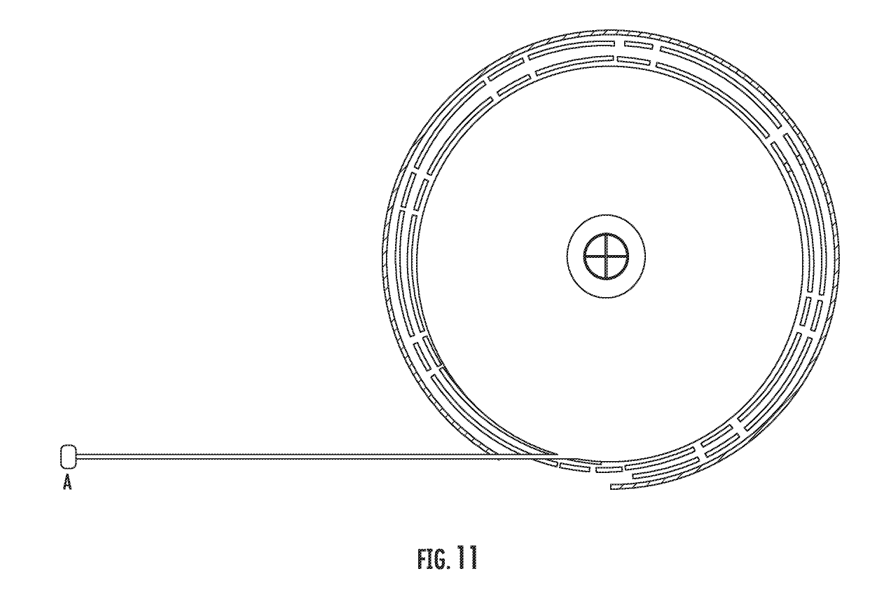

### DETAILED DESCRIPTION

A detailed description of one or more embodiments of the disclosed apparatus and method are presented herein by way of exemplification and not limitation with reference to the Figures.

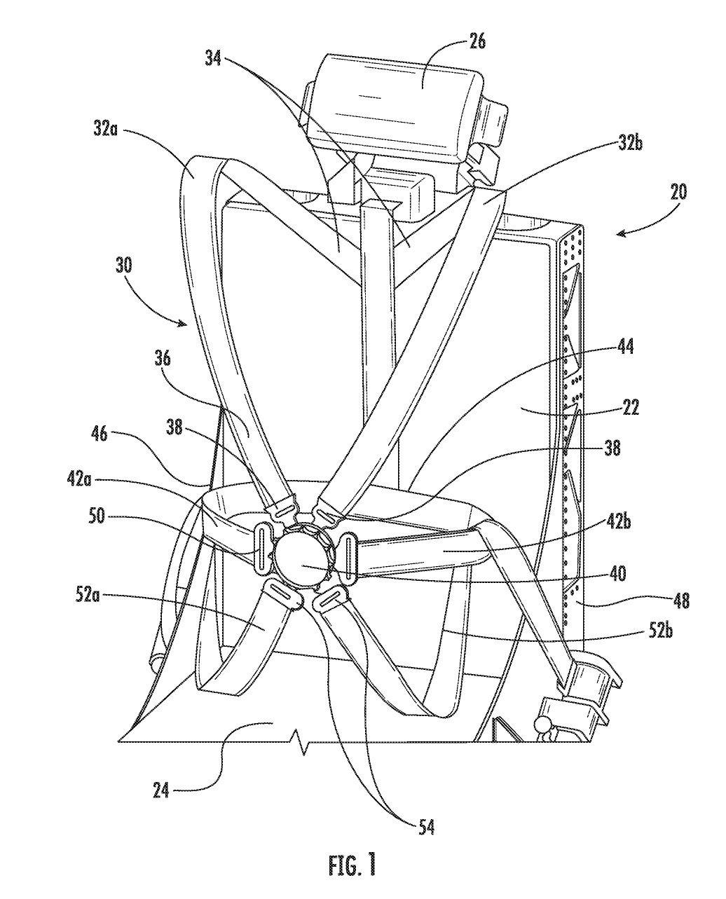

With reference now to FIG. 1, an example of a seat 20 used in a vehicle, such as an aircraft, and more specifically a helicopter, for example, is illustrated. As shown, the seat 20 typically includes a seat back 22 and a seat bottom 24 for supporting an occupant of the vehicle. In some embodiments, the seat 20 may additionally include other conventional equipment, including, but not limited to, a headrest 26 and/or a seat cushion (not shown) for example.

A harness system 30 is integrated with the seat 20. The harness system 30 includes one or more pieces of webbing 32 for restraining one or both shoulders of an occupant of the seat. In the illustrated, non-limiting embodiment, the harness system 30 includes a first shoulder strap 32a and a second shoulder strap 32b, each of which passes over a corresponding shoulder of the occupant. A first end 34 of each of the shoulder straps 32a, 32b is anchored relative to the seat 20, and a second end 36 of the shoulder straps 32a, 32b is configured to be restrained in any suitable manner at a front of the occupant. For example, a connector 38 located at the second end 36 of each shoulder strap 32a, 32b may detachably couple to a quick release buckle 40. Harness systems 30 having only a single shoulder strap that extends generally across a torso of the seat occupant are also contemplated herein.

The harness system 30 additionally includes at least one piece of webbing 42 that functions as a lap belt, to restrain a lower torso of an occupant of the seat 20. A first end 44 of the lap belt 42 is anchored to a side of the seat 20 and extends at least partially across the lap of the occupant. In the illustrated embodiment, both a first lap belt 42a and a second lap belt 42b extend from opposing sides 46, 48 of the seat 20 and include a connector 50 configured to detachably couple to the same quick release buckle 40 as the one or more shoulder straps 32a, 32b.

Alternatively, or in addition, in some embodiments, the harness system 30 may include one or more pieces of webbing 52 that wrap around a portion of an occupant's leg to restrain the leg relative to the seat 20. The leg straps 52 may be anchored to a portion of the seat 20, or alternatively, to another piece of webbing of the harness system 30, such as an adjacent lap belt 42a, 42b for example (as shown in FIG. 1). In the illustrated non-limiting embodiment, both a first leg strap 52a and a second leg strap 52b extend from opposing sides of the harness system 30 and include connectors 54 configured to detachably couple to the same quick release buckle 40 as the remainder of the straps of the harness system 30. However, embodiments where one or more of the at least one leg strap 52, the one or more shoulder straps 32, and lap belts 42 connect to different quick release buckles 40 are also contemplated herein.

The harness system 30 illustrated and described herein is a six-point system, because six different belts or pieces of webbing wrap about an occupant's body to selectively affix to the quick release buckle 40. However, it should be understood that the harness system 30 shown is intended as an example only and that a multi-point harness system 30 having any suitable configuration is contemplated herein. Further, although the pieces of webbing 32, 42, and 52 of the harness 30 are illustrated and described as being affixed to the seat 20, it should be understood that in other embodiments, one or more pieces of webbing of the harness 30 may be anchored to any stationary surface, such as a ceiling, wall, or floor of the vehicle, adjacent the seat 20.

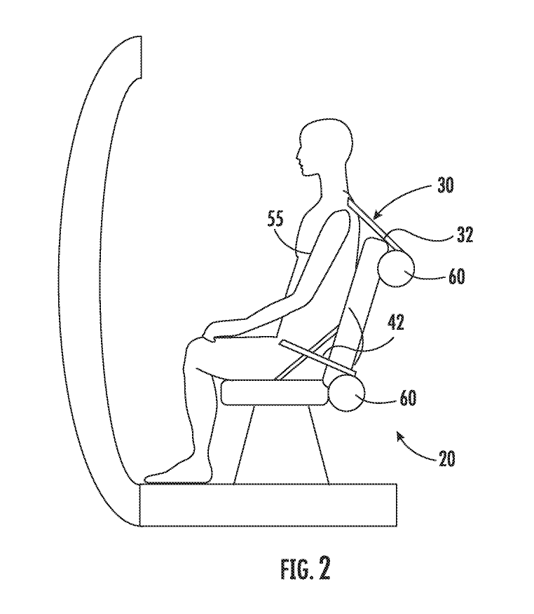

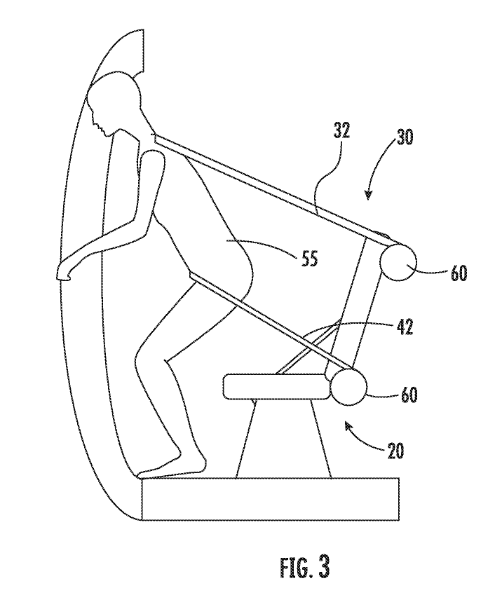

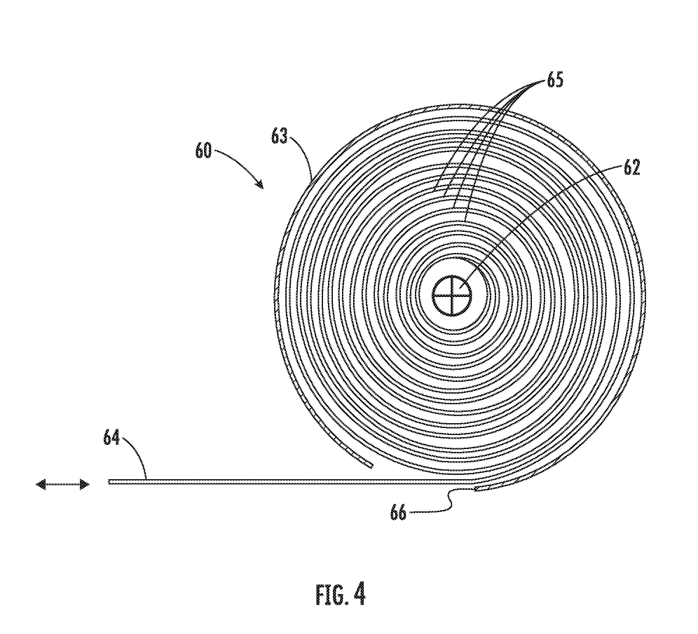

With reference now to FIGS. 2 and 3, a person 55 is shown seated within the interior of a vehicle, such as a cabin of an aircraft, for example. The person 55 is wearing a harness system, such as system 30, integrated with the seat 20. As shown both a lap belt 42 and a shoulder strap 32 are secured to a respective inertia reel 60 mounted to the seat. However, it should be understood that any piece of webbing of the harness 30 may be coupled to an inertia reel 60, and that the inertia reel 60 may be located at any location about the seat 20 or adjacent to the seat 20. As best shown in FIG. 4, each inertia reel 60 comprises a spool 62 rotatably mounted within a housing 63 about which is wound a length of webbing 64. Due to extended length of webbing 64, multiple layers 65 of webbing 64 are wrapped concentrically about the spool 62.

Inside the spool 62, an inertia mechanism (not shown) allows substantially unrestricted payout of the webbing 64 provided that the webbing 64 is pulled from the inertia reel 60 in a substantially steady manner. However, if the webbing 64 is pulled via a sudden jerk or acceleration, the inertia mechanism locks to restrict further release of the webbing 64. Further, the inertia mechanism may be spring biased so as to reel in the webbing 64 unless a predetermined force is applied to the webbing 64.

In the configuration illustrated in FIG. 2, an occupant 55 is securely seated within the seat 20 by the harness 30 affixed about his person. The person 55 is typically seated during take-off and landing of the vehicle for example. With respect to the configuration of FIG. 3, the occupant remains securely tethered to the seat 20 by way of the harness 30 and its associated inertia reels, thereby preventing the occupant from falling out of an adjacent opening (not shown) in the vehicle. However, as shown, the occupant is allowed a significant degree of freedom to move and complete one or more mission tasks via the extended length of the webbing 64.

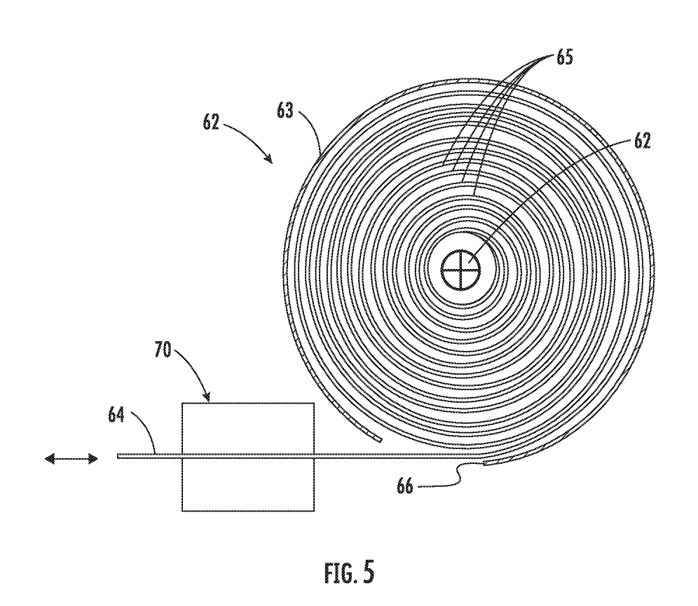

With reference now to FIGS. 5-7, in an embodiment, a locking mechanism 70 is disposed downstream from an outlet 66 of the inertia reel 60. In the illustrated non-limiting embodiments, the locking mechanism 70 is selectively operable to apply a compressive or clamping force against a surface of the webbing 64, thereby restricting movement of the webbing 64. As shown, the locking mechanism 70 includes a first portion 72 disposed adjacent a first side 74 of the webbing 64 and a second portion 76 disposed adjacent a second, opposite side 78 of the webbing 64. The first portion 72 may include a first contact member 77 configured to contact the first side 74 of the webbing 64. In some embodiments, the second portion 76 may similarly include a second contact member 79 configured to contact the second side 78 of the webbing 64. The first and/or second contact members 77, 79 may be formed from any suitable material, including but not limited to rubber. In an embodiment, the first and second contact members 77, 79 are textured, i.e. knurled, to enhance the contact with the webbing 64 without damaging the webbing 64.

The first and second portions 72, 76 may be contained within a housing 80, having an inlet opening 82 and an outlet opening 84, through which the webbing 64 extends, or alternatively, may be freely mounted, such as to a portion of the seat 20 or at a position near the inertia reel 60. In an embodiment, at least one of the inlet opening 82 and the outlet opening 84 has a bell mouth.

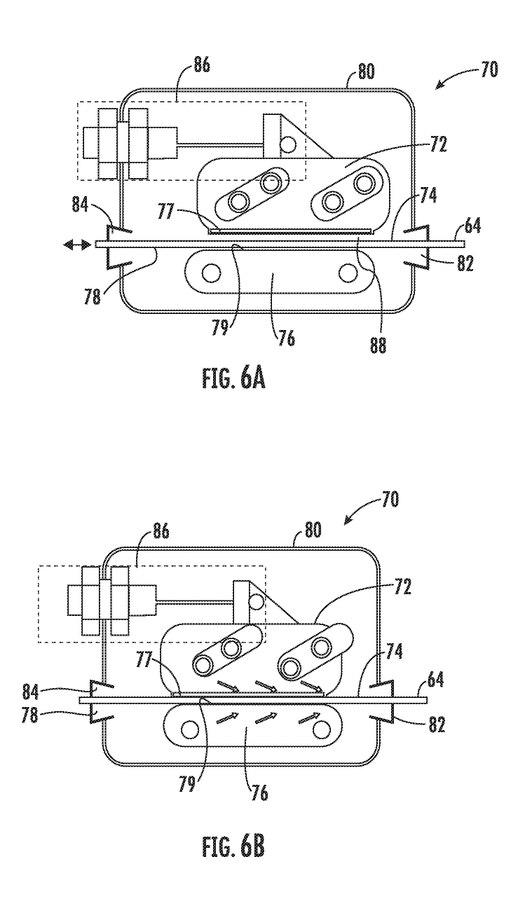

The first portion 72 of the locking mechanism 70 is operably coupled to a control device 86, such as a handle, an actuator, or a control cable assembly for example. The control device 86 is configured to control movement of the first portion 72 of the locking mechanism 70 between a first position (FIG. 6A, 7A) and a second position (FIG. 6B, 7B). In the first position, the first portion 72 is offset from the second portion 76 such that a gap or clearance 88 exists there between. A portion of the webbing 64 released from the inertia reel 60 is positioned within and is freely movable through this gap 88.

When the locking mechanism 70 is in the second position, the first portion 72 is moved toward the second portion 76 such that the webbing 64 is sandwiched between the first and second portions 72, 76. As the first portion 72 moves into contact with the second portion 76, a compressive force is applied to the opposing surfaces 74, 78 of the webbing 64, thereby restricting movement of the webbing 64 relative to the locking mechanism 70. The locking mechanism 70 is therefore able to constrain the webbing 64 without applying a load to the inertia reel 60 or to the portion of the webbing 64 contained therein.

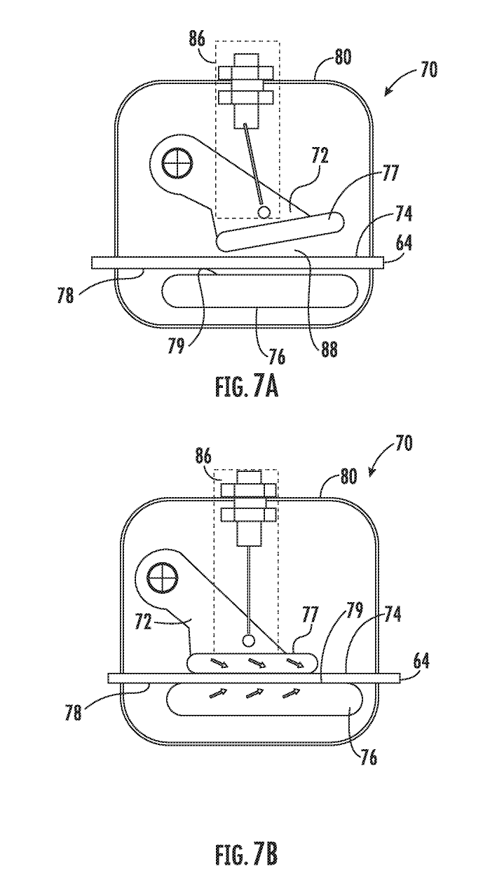

The first portion 72 may be configured to move linearly, as shown in FIGS. 6A and 6B. In another embodiment, the first portion may be configured to pivot about an axis X, as shown in FIGS. 7A and 7B. In such embodiments, a biasing mechanism (not shown) may be coupled to the pin defining the axis of rotation. The biasing force of the biasing mechanism is configured to bias the first portion 72 into the second position and into contact with the second portion 76 to restrict movement of the webbing 64. However, the control device 86 may be operable to oppose the biasing force to retain the locking mechanism 70 in the first position. Further, although the first portion 72 is illustrated and described as being movable and the second portion 76 is illustrated and described as being stationary, it should be understood that in other embodiments, the second portion 76 may be movable and the first portion 72 may be stationary, or alternatively, both the first and second portions 72, 76 may be movable relative to one another.

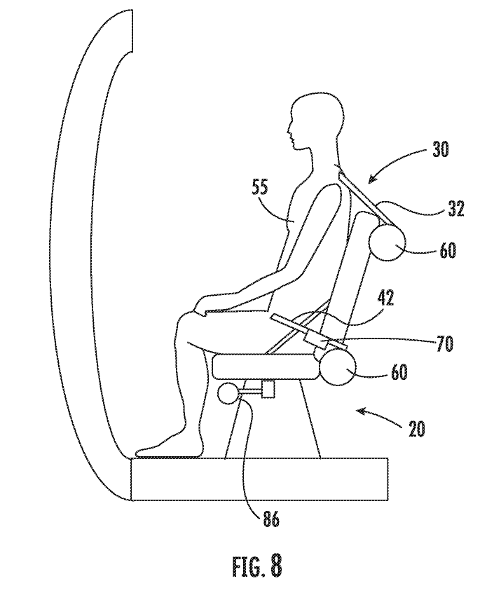

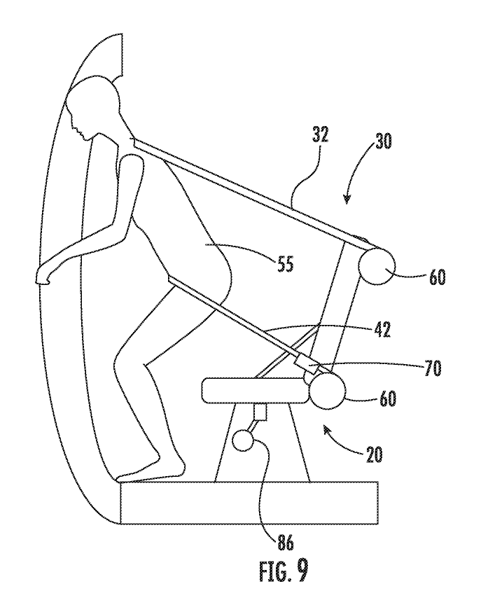

With reference now to FIGS. 8 and 9, the seat 20 is illustrated including the harness 30 having at least one locking mechanism 70. As shown, the control device 86 for selectively operating the locking mechanism 70 may be mounted to a side of the seat 20 at a position easily accessible by the occupant 55. The occupant may manually manipulate the control device 86 to activate the locking mechanism 70 when the occupant is not in the seated position.

In addition to the inertia reel, which functions as a primary locking mechanism for restricting undesired movement of the webbing 64, the locking mechanism 70 illustrated and described herein provides a secondary locking mechanism for restricting movement of an occupant relative to a seat during a high acceleration, such as of a severe maneuver, crash, or other impact even. By clamping the webbing 64 at a position downstream from the outlet of an inertia reel 60, the locking mechanism 70 restricts movement of the webbing 64 relative to the occupant, even when additional webbing 64 is paid out from the inertia reel 60 due to compression of the layers 65 of webbing 64 wrapped about the spool 62, as shown in FIG. 22.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A harness comprising:
a primary locking mechanism;
at least one strap of webbing coupled to a primary locking mechanism; and
a secondary locking mechanism associated with the at least one strap of webbing, the secondary locking mechanism being located downstream from the primary locking mechanism, the secondary locking mechanism being movable to selectively contact the at least one strap of webbing to restrict movement of the at least one strap of webbing relative to the secondary locking mechanism.

2. The harness of claim 1, wherein the secondary locking mechanism is movable to restrict movement of the at least one strap of webbing without applying a load to the primary locking mechanism.

3. The harness of claim 1, wherein the secondary locking mechanism further comprises:
a first portion; and
a second portion, the first portion being movable relative to the second portion between a first position and a second position, wherein in the first position, a clearance is defined between the first portion and the second portion.

4. The harness of claim 3, wherein the at least one strap of webbing extends through the clearance.

5. The harness of claim 3, wherein when the first portion and the second portion are in the second position, the at least one strap of webbing is clamped between the first portion and the second portion.

6. The harness of claim 3, wherein the first portion is linearly movable between the first position and the second position.

7. The harness of claim 3, wherein the first portion is rotatable between the first position and the second position.

8. The harness of claim 3, wherein the first portion includes a first contact member, wherein engagement between the first contact member and the at least one strap of webbing does not damage the at least one strap of webbing.

9. The harness of claim 8, wherein the first contact member is formed from a rubber material.

10. The harness of claim 3, further comprising a control device coupled to the first portion to control movement of the first portion relative to the second portion between the first position and the second position.

11. The harness of claim 10, wherein the control device is manually operable by an occupant wearing the harness.

12. The harness of claim 10, wherein the control device is one of an actuator and a control cable assembly.

13. The harness of claim 10, wherein the locking mechanism further comprises a biasing mechanism that biases the first portion into the second position.

14. The harness of claim 12, wherein the control device is operable to oppose the biasing mechanism to retain the first portion in the first position.

15. The harness of claim 1, wherein the primary locking mechanism includes an inertia reel, the at least one strap of webbing being affixed to and wound about a spool of the inertia reel.

16. The harness of claim 15, wherein the secondary locking mechanism is arranged downstream from an outlet of the inertia reel.

17. The harness of claim 1, wherein the harness is coupled to a seat.

18. The harness of claim 17, wherein the harness allows a user to move between a seated position and a standing position, and in the standing position the user may perform one or more mission tasks.

19. The harness of claim 1, wherein the harness is integrated into a vehicle.

20. The harness of claim 19, wherein the vehicle is an aircraft.
